(19) United States
(12) Patent Application Publication
(10) Pub. No.: US 2026/0192592 A1
(43) Pub. Date: Jul. 9, 2026

(54) SHAVING COMPRESSION MECHANISM OF PENCIL SHARPENER, AND PENCIL SHARPENER

(71) Applicant: Ningbo Tiantian Stationery Co., Ltd., Ningbo (CN)

(72) Inventors: Gaowei Zheng, Ningbo (CN); Fanbi Zeng, Ningbo (CN); Feng Cao, Ningbo (CN); Chongzhi Zheng, Ningbo (CN); Fengjie Lin, Ningbo (CN)

(21) Appl. No.: 19/032,455

(22) Filed: Jan. 21, 2025

(30) Foreign Application Priority Data
Jan. 8, 2025 (CN) 202520044661.8

(51) Int. Cl. B43L 23/00; B43L 23/04

(52) U.S. Cl. CPC B43L 23/008; B43L 23/04

(57) ABSTRACT

A shaving compression mechanism of a pencil sharpener, and a pencil sharpener are disclosed. The shaving compression mechanism of the pencil sharpener includes: a conveying member provided in a shaving box, the conveying member being located below a cutting position; and a power source, the power source being connected with the conveying member and configured to drive the conveying member to rotate, the conveying member rotating to convey shavings that fall onto the conveying member to a distal end in the shaving box. In the shaving compression mechanism of the pencil sharpener, the shavings are effectively conveyed to the distal end in the shaving box and are compacted through the rotation of the conveying member, thus optimizing the space utilization of the shaving box, reducing the piling of the shavings, decreasing the difficulty in clearing, and improving the cleanliness and stability of the pencil sharpener.

### CROSS REFERENCE TO RELATED APPLICATIONS

The present application claims the benefit of Chinese Patent Application No. 202520044661.8 filed on Jan. 8, 2025, the contents of which are incorporated herein by reference in their entirety.

### TECHNICAL FIELD

The present application relates to the technical field of pencil sharpeners, and in particular to, a shaving compression mechanism of a pencil sharpener, and a pencil sharpener.

### BACKGROUND

In the existing horizontal pencil sharpener designs, the shavings produced in the sharpening process usually fall directly below the cutting position, causing concentrated piling. The concentrated piling may easily lead to insufficient space utilization of the shaving box, especially in an area far away from the cutting position where a few of shavings are accumulated, resulting in space waste. Moreover, the piling of the shavings below the cutting position also increases the difficulty in clearing the shavings, which may cause the shavings to spill out of the shaving box or influence the normal operation of the pencil sharpener.

### SUMMARY

The present application is intended to solve one of technical problems in the related arts to some extent. For this purpose, an embodiment of the present application provides a shaving compression mechanism of a pencil sharpener, in which shavings are effectively conveyed to a distal end in a shaving box and through the rotation of a conveying member, thus optimizing the space utilization of the shaving box, reducing the piling of the shavings, decreasing the difficulty in clearing, and improving the cleanliness and stability of the pencil sharpener.

An embodiment of the present application further provides the pencil sharpener with the shaving compression mechanism of the pencil sharpener described above.

The present application adopts the following technical solutions: provided is a shaving compression mechanism of a pencil sharpener, including:
a conveying member provided in a shaving box, the conveying member being located below a cutting position; and
a power source, the power source being connected with the conveying member and configured to drive the conveying member to rotate,
the conveying member rotating to convey shavings that fall onto the conveying member to a distal end in the shaving box.

After adopting the above structure, the shavings are no longer piled below the cutting position, but are effectively conveyed to an area at the distal end in the shaving box far away from the cutting position through the rotation of the conveying member. In this way, the space inside the shaving box is more evenly and fully utilized, and the concentrated piling of the shavings in an area close to the cutting position is avoided, thus improving the space utilization rate of the shaving box. Moreover, the conveying member can also compact the shavings, thus reducing the risk of spilling or excessive piling of the shavings, improving the ability of the shaving box to store shavings, and helping to maintain the cleanliness and stable operation of the pencil sharpener.

According to an embodiment of the present application, the conveying member is directly connected with the power source, that is, the power source directly drives the conveying member to rotate synchronously; or
the conveying member is connected with the power source through a transmission structure, that is, the power source drives the conveying member to rotate asynchronously or at a different speed.

According to an embodiment of the present application, the transmission structure comprises a gear set or a coil spring configured to provide transmission power; when the power source is connected with the conveying member through the gear set, the gear set can change a transmission ratio to transmit the rotational force generated by the power source to the conveying member, causing it to rotate at a different speed, and thus driving the shavings to be conveyed along the surface of the conveying member to the distal end in the shaving box. When the power source is connected with the conveying member through the coil spring, the power source provides additional driving force to store energy in the coil spring. In a case that the power source stops or an abnormal situation occurs, the coil spring drives the conveying member to rotate asynchronously.

According to an embodiment of the present application, the power source comprises a hand-cranked wheel and a motor; when the power source is the hand-cranked wheel, that is, the pencil sharpener is a manual pencil sharpener, the user drives the conveying member to rotate by rotating the hand-cranked wheel, and the user does not need to rely on an external power source, making it suitable for scenarios where it needs to be portable or there is no power.

On the other hand, when the power source is the motor, the pencil sharpener may automatically operate through the gear set driven by the motor, thus reducing the labor intensity of manual operation and improving the convenience and efficiency in use.

According to an embodiment of the present application, the power source drives a cutter holder at the cutting position to rotate; that is, the power source may be regarded as driving the conveying member separately, or as simultaneously driving the conveying member and the cutter holder. In the case of driving the conveying member separately, the power source drives the rotation of the conveying member, thus conveying the shavings from the cutting position to the distal end in the shaving box; the rotation of the cutter holder is driven by another independent driving system to ensure the normal progress of the sharpening process. In the case of simultaneously driving the conveying member and the cutter holder, the power source drives the cutter holder to rotate through the transmission system to perform the sharpening operation, while driving the conveying member to rotate to convey the shavings, thus achieving the coordinated work of pencil sharpening and shaving conveying.

According to an embodiment of the present application, a box body of the shaving box is detachably connected with a main body of the pencil sharpener; and/or
the box body of the shaving box is fixed to the main body of the pencil sharpener, and the box body is provided with a lid that is openable and closable; in the detachable connection design, the shaving box can be easily removed from the main body of the pencil sharpener, thus facilitating the clearing of the shavings and the replacement or cleaning of the shaving box. The user can easily remove the shaving box, thus ensuring regular cleaning, avoiding excessive piling of the shavings, and ensuring the normal operation of the pencil sharpener. In the fixed connection design with a lid that is closable and openable, the shaving box is always fixed to the main body of the pencil sharpener during use, thus increasing stability and convenience in use. The design that the lid is closable and openable facilitates the pouring of the shavings and the cleaning of the box body, avoid the spilling of the shavings, and maintain the cleanness of the working environment.

According to an embodiment of the present application, the conveying member is provided with a spiral blade; the spiral blade design can effectively guide and convey the shavings from the cutting position to the distal end in the shaving box. When the power source drives the conveying member to rotate, the spiral blade generates a forward pushing force through rotation, gradually pushing and conveying the shavings that fall on it to the area at the distal end in the shaving box. This spiral transmission structure can not only improve the conveying efficiency of the shavings, but also effectively prevent the shavings from getting stuck or retained in the conveying process.

According to an embodiment of the present application, the conveying member is rotatably connected with the box body of the shaving box through a connecting member, and the connecting member can drive the conveying member to rotate relative to the box body inside the box body. The arrangement of the connecting member facilitates the assembly of the conveying member.

According to an embodiment of the present application, the connecting member is provided with a connecting part configured to connect the power source; and/or
the connecting member is provided with a limiting part in limiting fit with the box body, and the limiting part is configured to limit an axial position of the connecting member; and/or
the connecting member is provided with a fastening part, and the fastening part passes through a connecting column on the box body and is connected with the conveying member in a clamping manner.

A pencil sharpener includes the shaving compression mechanism of the pencil sharpener described above.

### BRIEF DESCRIPTION OF THE DRAWINGS

To describe the technical solutions in the embodiments of the present application or in the existing technologies more clearly, the accompanying drawings required for describing the embodiments or existing technologies are briefly described below. Apparently, the accompanying drawings in the following description show only some embodiments of the present application, and those skilled in the art may still derive other drawings from these accompanying drawings without creative efforts.

FIG. 1 is a 3D diagram of a pencil sharpener in an embodiment of the present application.

FIG. 2 is a side view of a pencil sharpener in an embodiment of the present application.

FIG. 3 is a sectional view of a pencil sharpener in an embodiment of the present application.

FIG. 4 is a schematic structural diagram of a pencil sharpener in an embodiment of the present application.

FIG. 5 is a schematic structural diagram of a gear set and a conveying member in an embodiment of the present application.

FIG. 6 is an exploded view of a gear set and a conveying member in an embodiment of the present application.

FIG. 7 is a schematic structural diagram of a box body in an embodiment of the present application.

FIG. 8 is a 3D diagram of a box body in an embodiment of the present application.

FIG. 9 is an exploded view of a box body in an embodiment of the present application.

FIG. 10 is a 3D diagram of a shaving compression mechanism of a pencil sharpener in an embodiment of the present application.

### DESCRIPTION OF REFERENCE SIGNS

10—main body; 20—shaving box;
11—housing; 12—power source; 13—gear set; 14—supporting frame; 15—cutter holder; 16—pencil feeding component; 17—connecting gear;
11a—inner cavity; 11b—mounting groove; 11c—insertion hole;
15a—hobbing cutter;
17a—inner spline;
21—box body; 22—conveying member; 23—connecting member;
21a—shaving collection chamber; 21b—connecting column;
22a—spiral blade; 22b—inner hole;
23a—connecting part; 23b—limiting part; and 23c—fastening part

### DETAILED DESCRIPTION

The embodiments of the present application will be described below in detail. Examples of the embodiments are shown in the accompanying drawings. The same or similar reference signs in all the accompanying drawings indicate the same or similar components or components having the same or similar functions. The embodiments described below with reference to the accompanying drawings are exemplary, are merely intended to explain the present application and cannot be construed as limitations to the present application.

### EMBODIMENT 1

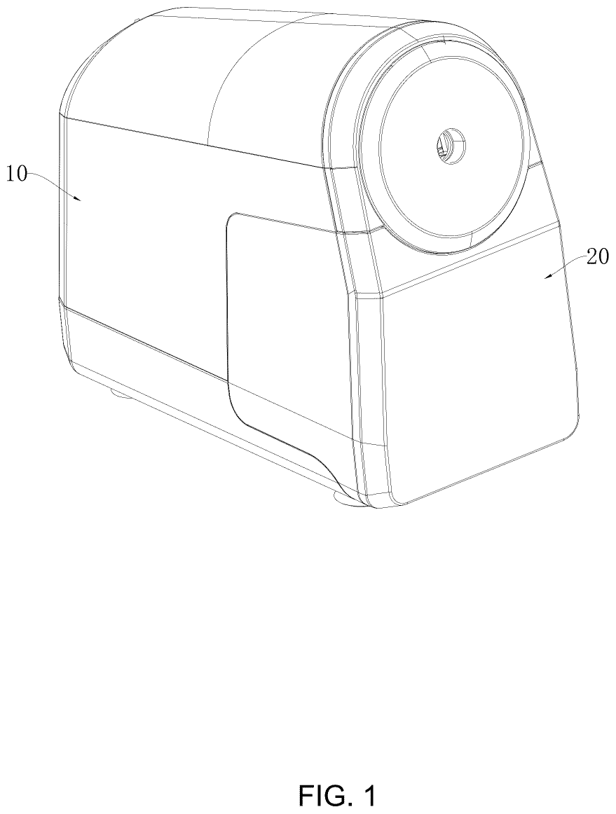

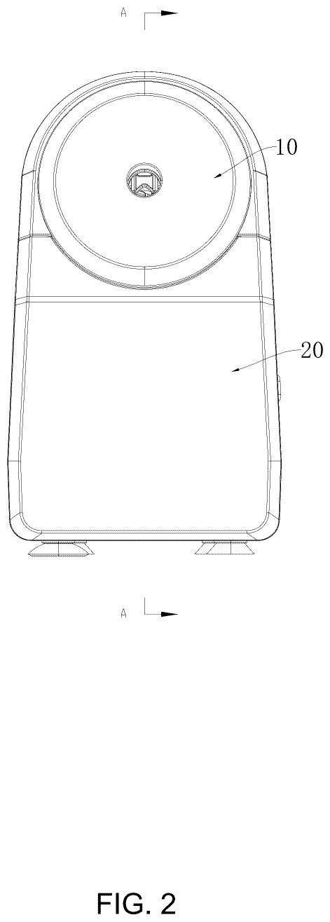

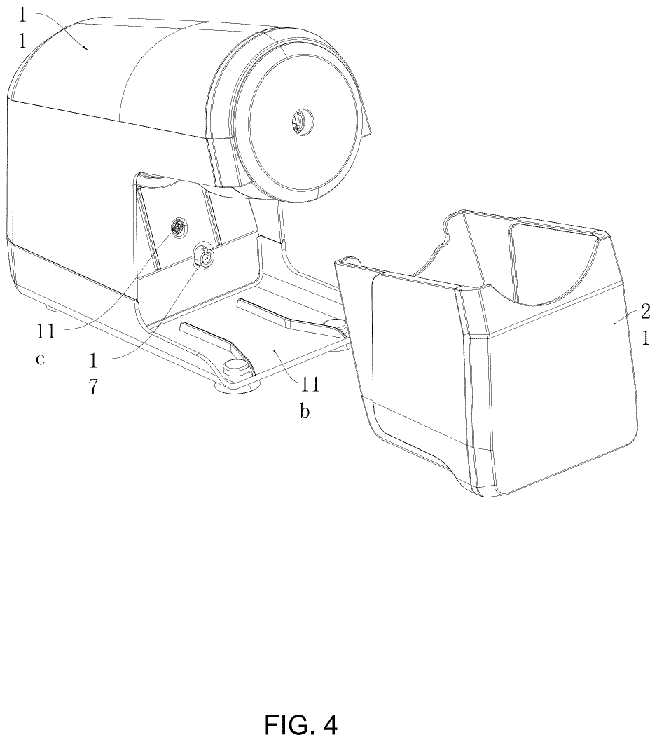

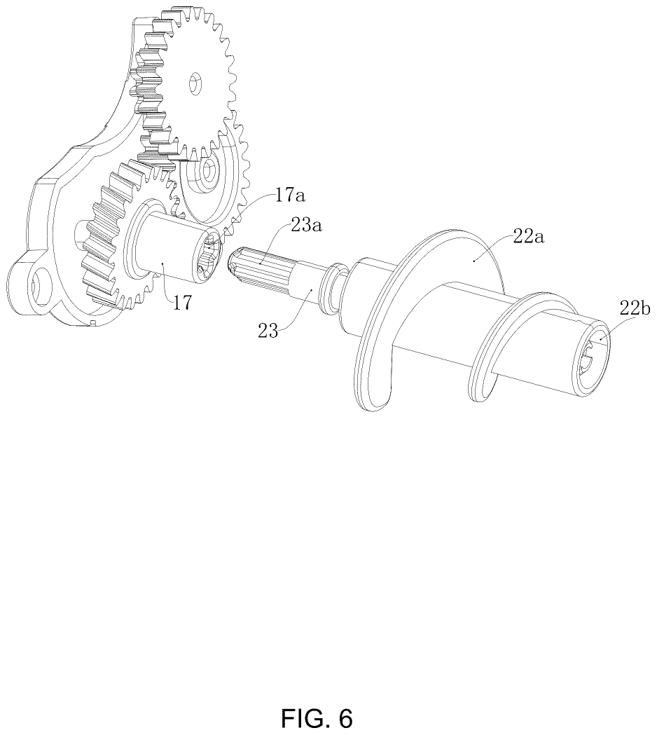

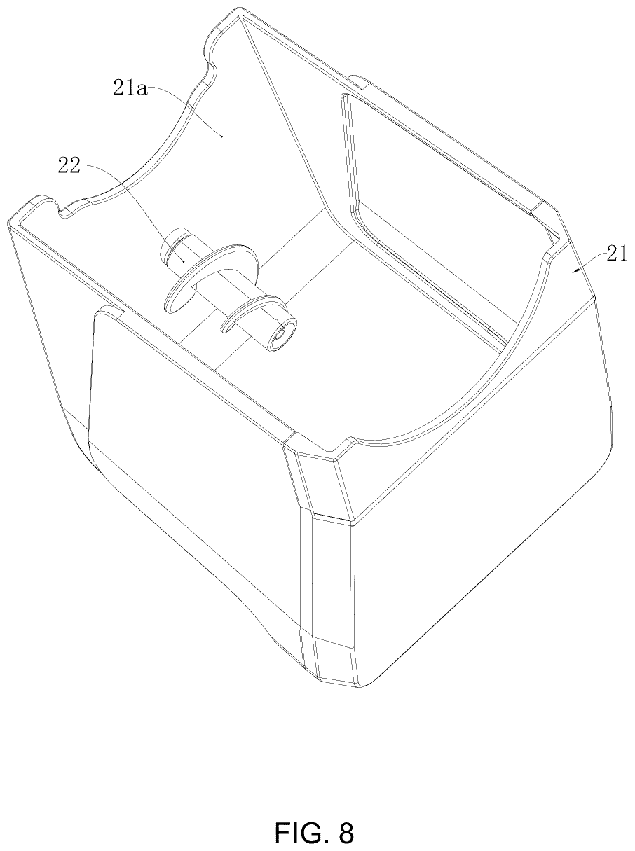

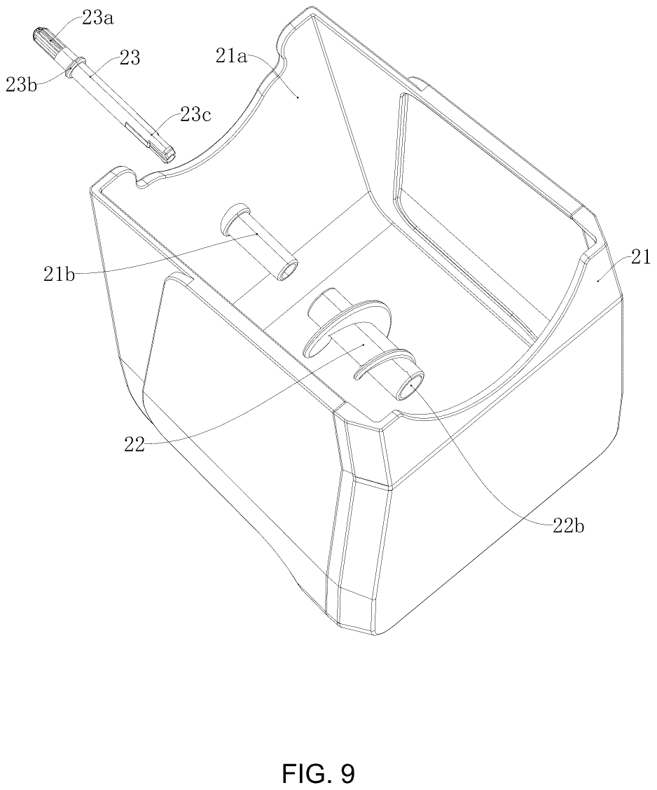

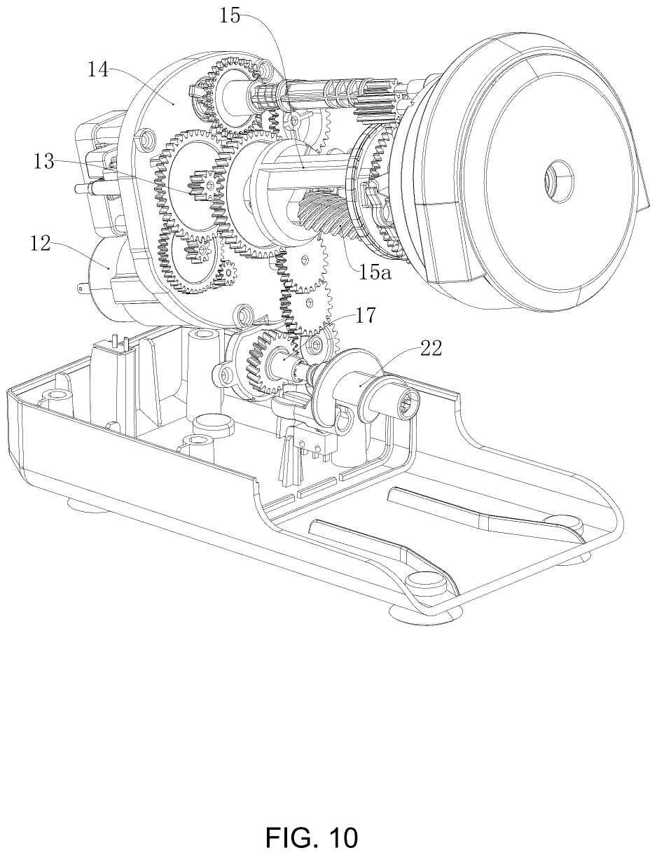

Referring to FIG. 1 to FIG. 10, this embodiment discloses a shaving compression mechanism of a pencil sharpener, including:
a conveying member 22 provided in a shaving box 20, the conveying member 22 being located below a cutting position; and
a power source 12, the power source 12 being connected with the conveying member 22 and configured to drive the conveying member 22 to rotate.

The conveying member 22 rotates to convey shavings that fall onto the conveying member to a distal end in the shaving box 20.

Further, the power source 12 is a motor that may drive both the conveying member 22 and the cutter holder 15 to rotate. The cutter holder 15 is located at the cutting position and performs a cutting operation on a pencil tip. Wood chips and lead debris cut down fall to the position of the conveying member 22. The conveying member 22 conveys the wood chips and the lead debris to other areas inside the shaving box 20. In some embodiments, the power source 12 is a hand-cranked wheel configured to manually drive the conveying member 22 to rotate. In other embodiments, the power source 12 is only configured to drive the conveying member 22 to rotate, while the cutter holder 15 at the cutting position is driven by another independent power system.

Further, in this embodiment, the shaving box 20 is a drawer-type shaving box 20. The shaving box 20 is detachably connected with a main body 10 of the pencil sharpener. An opening for receiving shavings is provided in an upper end of the shaving box 20. In some other embodiments, the shaving box 20 is fixedly mounted on the main body 10 of the pencil sharpener. The shaving box 20 is provided with a side-opening lid (not shown). The lid may be opened to pour out the shavings inside the shaving box 20 for ease of clearing and maintenance.

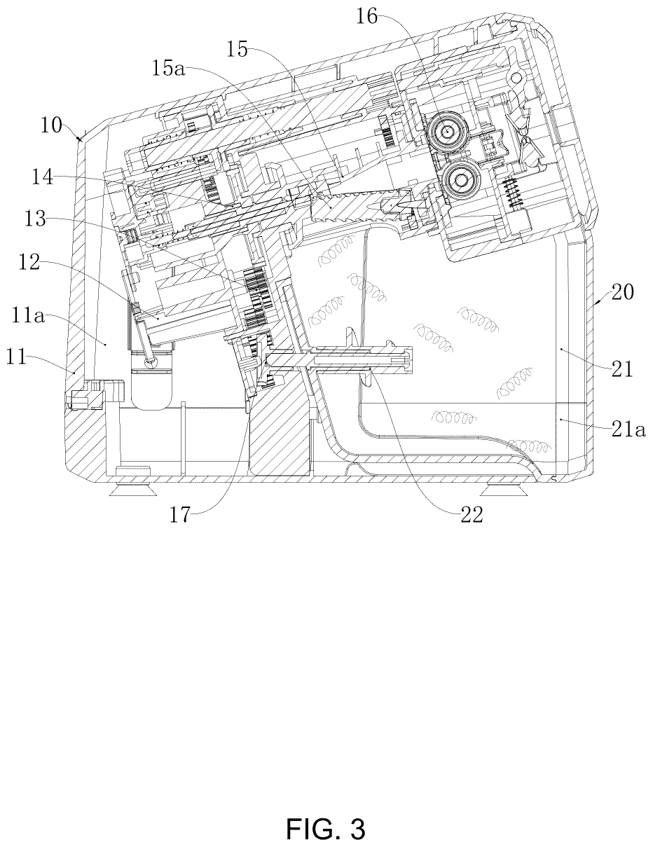

Referring to FIG. 3, in this embodiment, the power source 12 is a motor. A gear on an output shaft of the motor is engaged with a gear set 13. The gear set 13 is mounted on a supporting frame 14 and connected with one end of the cutter holder 15 through a spline to drive the cutter holder 15 to rotate. The rotation of the cutter holder 15 drives a pencil feeding component 16 to perform a pencil feeding action. One gear of the gear set 13 is connected with a connecting gear 17. The connecting gear 17 is connected with the conveying member 22 through a spline to further drive the conveying member 22 to rotate to convey the shavings to an area at the distal end in the shaving box 20. This transmission structure enables the power source 12 to simultaneously drive the cutter holder 15 and the conveying member 22, thus optimizing the coordination of pencil sharpening and shaving conveying.

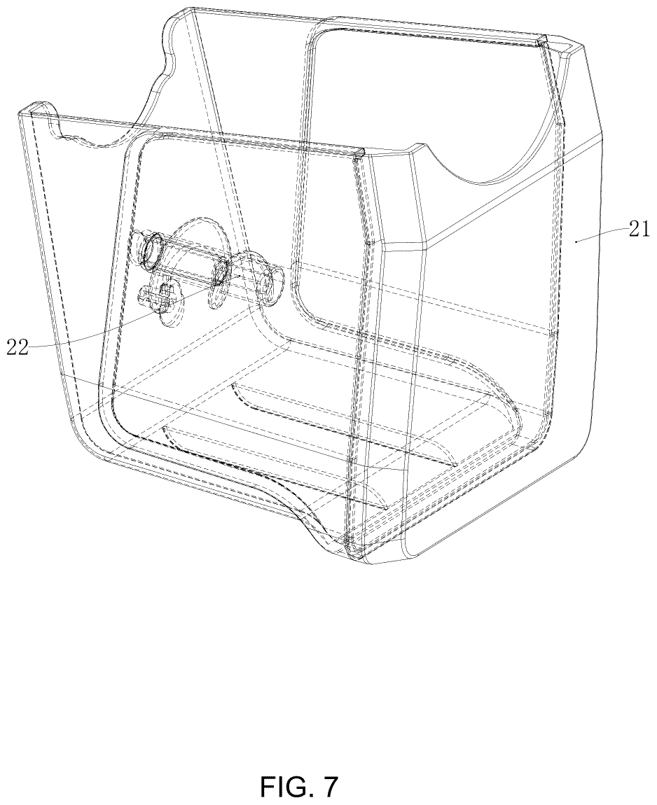

Specifically, referring to FIG. 7 to FIG. 9, a box body 21 of the shaving box 20 is detachably connected with the main body 10 of the pencil sharpener. The conveying member 22 is provided with a spiral blade 22a.

Further, in this embodiment, the main body 10 of the pencil sharpener includes a housing 11, a power source 12, a gear set 13, a supporting frame 14, a cutter holder 15, a pencil feeding component 16, and a connecting gear 17. The supporting frame 14 is provided in an inner cavity 11a of the housing 11. The power source 12 is a motor. The motor, the gear set 13, and the connecting gear 17 are all mounted on the supporting frame 14. One end of the cutter holder 15 is connected with a gear of the gear set 13 through a spline, and the other end is connected with the pencil feeding component 16. A hobbing cutter 15a is provided on the cutter holder 15. The cutter holder 15 is arranged diagonally. A mounting groove 11b is provided outside the main body 10. The shaving box 20 is detachably mounted in the groove. A side wall of the groove is provided with an insertion hole 11c. When the shaving box 20 is placed in the mounting groove 11b, the opening in the upper end of the shaving box 20 is located below the hobbing cutter 15a, that is, directly below the cutting position.

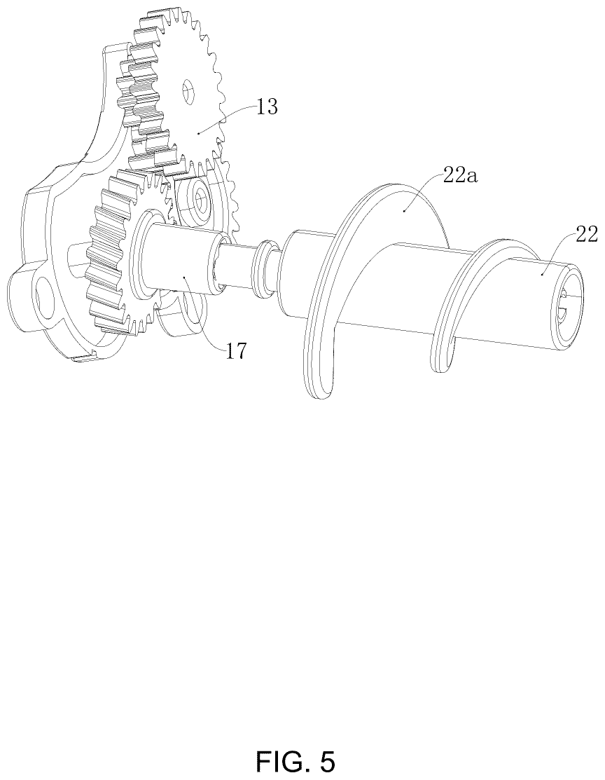

Specifically, referring to FIG. 5 to FIG. 10, in this embodiment, the conveying member 22 is rotatably mounted in the box body 21 of the shaving box 20 through a connecting member 23. The connecting member 23 is provided with a connecting part 23a configured to connect the power source 12. The connecting member 23 is provided with a limiting part 23b in limiting fit with the box body 21. The limiting part 23b is configured to limit an axial position of the connecting member 23. The connecting member 23 is provided with a fastening part 23c. The fastening part 23c passes through a connecting column 21b on the box body 21 and is connected with the conveying member 22 in a clamping manner.

Further, in this embodiment, the box body 21 of the shaving box 20 is provided with a connecting column 21b on the side close to the main body 10 of the pencil sharpener. The connecting column 21b is located in a shaving collection chamber 21a of the shaving box 20. The connecting column 21b is of a hollow structure. The conveying member 22 is provided with a spiral blade 22a and an inner hole 22b. The inner diameter of the inner hole 22b is adapted to the outer diameter of the connecting column 21b, so that the conveying member 22 can be in rotatable fit with the connecting column 21b. The spiral blade 22a is configured to drive the conveying of the shavings. One end of the connecting column 21b is the connecting part 23a, and the other end is the fastening part 23c. The fastening part 23c passes through the connecting column 21b and is connected with the conveying member 22 in a clamping manner. The connecting part 23a is of an outer spline structure. Correspondingly, the connecting gear 17 is provided with an inner spline 17a structure that is adapted to the connecting part 23a. The inner spline 17a is located in the insertion hole 11c. When the shaving box 20 is placed in the mounting groove 11b, the connecting part 23a passes through the insertion hole 11c and is connected with the inner spline 17a on the connecting gear 17, thus achieving torque transmission and driving the conveying member 22 to rotate.

Still further, a middle portion of the connecting member 23 is provided with a limiting part 23b. The limiting part 23b is of a shoulder structure protruding radially. Correspondingly, an inner step is provided inside the connecting column 21b, and the inner step abuts against the limiting part 23b, thus limiting the axial position of the connecting member 23 and the box body 21 of the shaving box 20. The fastening part 23c is connected with the conveying member 22 in a clamping manner to prevent the conveying member 22 from disengaging from the connecting column 21b, thus ensuring that the conveying member 22 is in stable fit with the connecting column 21b during working, and avoiding functional failure caused by axial displacement or looseness.

A pencil sharpener includes the shaving compression mechanism of the pencil sharpener described above.

In the description of the present application, it is to be understood that, orientation or position relationships indicated by the terms such as “center,” “longitudinal,” “transverse,” “length,” “width,” “thickness,” “up,” “down,” “front,” “back,” “left,” “right,” “vertical,” “horizontal,” “top,” “bottom,” “inside,” “outside,” “clockwise,” “anticlockwise,” “axial,” “radial,” and “circumferential” are based on orientation or position relationships shown in the accompanying drawings, and are used only for ease and brevity of illustration and description, rather than indicating or implying that the mentioned apparatus or component must have a particular orientation or must be constructed and operated in a particular orientation. Therefore, such terms shall not be construed as limitations to the present application.

In addition, terms “first” and “second” are used merely for the purpose of description, and shall not be construed as indicating or implying relative importance or implying a quantity of indicated technical features. Therefore, a feature defined by “first” or “second” may explicitly indicate or implicitly include at least one of such features. In the description of the present application, “multiple” means at least two, such as two, three or the like, unless otherwise specified.

In the present application, unless otherwise stated, terms such as “mounting,” “connected,” “connection” and “fixing” shall be understood in a broad sense. For example, it may be fixed connection, detachable connection, or integral connection. The connection may be a mechanical connection or an electrical connection or may communicate with each other. The connection may be a direct connection, an indirect connection through an intermediary, or internal communication between two elements or mutual action relationship between two elements, unless otherwise specified explicitly. Those of ordinary skill in the art may understand specific meanings of the terms in the present application according to specific situations.

In the present application, unless otherwise explicitly specified or defined, a first feature being located “above” or “below” a second feature may be that the first feature is in a direct contact with the second feature, or the first feature is in an indirect contact with the second feature through an intermediary. In addition, the first feature being “above,” “over,” or “on” the second feature may be that the first feature is directly above or obliquely above the second feature, or may merely indicate that the horizontal position of the first feature is higher than that of the second feature. The first feature being “below,” “underneath” or “under” the second feature may be that the first feature is directly below or obliquely below the second feature or may merely indicate that the horizontal position of the first feature is lower than that of the second feature.

In the description of this specification, the description with reference to terms “an embodiment,” “some embodiments,” “an example,” “a specific example,” “some examples” and the like means that specific features, structures, materials or characteristics described in combination with the embodiment(s) or example(s) are included in at least one embodiment or example of the present application. In this specification, schematic descriptions of the foregoing terms are not necessarily directed at the same embodiment or example. Besides, the specific features, the structures, the materials or the characteristics that are described may be combined in proper manners in any one or more embodiments or examples. In addition, a person skilled in the art may integrate or combine different embodiments or examples described in the specification and features of the different embodiments or examples as long as they are not contradictory to each other.

Although the embodiments of the present application have already been shown and described above, it is to be understood that the above embodiments are exemplary and cannot be understood as limitations to the present application. Those skilled in the art may make changes, modifications, replacements and variations to the above embodiments within the scope of protection of the present application.

What is claimed is:

1. A shaving compression mechanism of a pencil sharpener, comprising:
a conveying member provided in a shaving box, the conveying member being located below a cutting position; and
a power source, the power source being connected with the conveying member and configured to drive the conveying member to rotate,
the conveying member rotating to convey shavings that fall onto the conveying member to a distal end in the shaving box.

2. The shaving compression mechanism of the pencil sharpener according to claim 1, wherein the conveying member is directly connected with the power source; or
the conveying member is connected with the power source through a transmission structure.

3. The shaving compression mechanism of the pencil sharpener according to claim 2, wherein the transmission structure comprises a gear set or a coil spring configured to provide transmission power.

4. The shaving compression mechanism of the pencil sharpener according to claim 1, wherein the power source comprises a hand-cranked wheel and a motor.

5. The shaving compression mechanism of the pencil sharpener according to claim 1, wherein the power source drives a cutter holder at the cutting position to rotate.

6. The shaving compression mechanism of the pencil sharpener according to claim 1, wherein a box body of the shaving box is detachably connected with a main body of the pencil sharpener; and/or
the box body of the shaving box is fixed to the main body of the pencil sharpener, and the box body is provided with a lid that is openable and closable.

7. The shaving compression mechanism of the pencil sharpener according to claim 1, wherein the conveying member is provided with a spiral blade.

8. The shaving compression mechanism of the pencil sharpener according to claim 1, wherein the conveying member is rotatably connected with a box body of the shaving box through a connecting member, and the connecting member is capable of driving the conveying member to rotate relative to the box body inside the box body.

9. The shaving compression mechanism of the pencil sharpener according to claim 8, wherein the connecting member is provided with a connecting part configured to connect the power source; and/or
the connecting member is provided with a limiting part in limiting fit with the box body, and the limiting part is configured to limit an axial position of the connecting member; and/or the connecting member is provided with a fastening part, and the fastening part passes through a connecting column on the box body and is connected with the conveying member in a clamping manner.

10. A pencil sharpener, comprising the shaving compression mechanism of the pencil sharpener according to claim 1.

11. A pencil sharpener, comprising the shaving compression mechanism of the pencil sharpener according to claim 2.

12. A pencil sharpener, comprising the shaving compression mechanism of the pencil sharpener according to claim 3.

13. A pencil sharpener, comprising the shaving compression mechanism of the pencil sharpener according to claim 4.

14. A pencil sharpener, comprising the shaving compression mechanism of the pencil sharpener according to claim 5.

15. A pencil sharpener, comprising the shaving compression mechanism of the pencil sharpener according to claim 6.

16. A pencil sharpener, comprising the shaving compression mechanism of the pencil sharpener according to claim 7.

17. A pencil sharpener, comprising the shaving compression mechanism of the pencil sharpener according to claim 8.

18. A pencil sharpener, comprising the shaving compression mechanism of the pencil sharpener according to claim 9.
